(19) United States
(12) Patent Application Publication
(10) Pub. No.: US 2025/0371244 A1
(43) Pub. Date: Dec. 4, 2025

(54) FONT MANAGEMENT ENGINE IN A DESIGN SYSTEM

(71) Applicant: Microsoft Technology Licensing, LLC, Redmond, WA (US)

(72) Inventors: Aryan SINGH, Noida (IN); Sumithra BHAKTHAVATSALAM, Kirkland, WA (US); Akshiv BALUJA, New Delhi (IN)

(21) Appl. No.: 18/680,096

(22) Filed: May 31, 2024

(51) Int. Cl. G06F 40/109; G06T 11/00

(52) U.S. Cl. CPC G06F 40/109; G06T 11/00

(57) ABSTRACT

Methods, systems, and computer storage media for providing font management using a font management engine in a design system are described. The font management engine recommends font pairs that include a heading font and a subheading font. In operation, font category descriptions are generated for font categories mapped to fonts. Font category embeddings for font category descriptions are generated. Prompt embeddings for a prompt are generated. Using the font category embeddings, the prompt embeddings, and the font categories, at least one heading font candidate is identified. Using a font pairing operation, at least one subheading font candidate for the at least one heading font candidate is identified. At least one font pairing is identified. The at least one font pairing is identified based on the at least one font heading candidate and the at least one subheading font candidate. The font pairing comprises a heading font and a subheading font.

### BACKGROUND

Users rely on graphics editors or image editors to accomplish digital design tasks. A design system provides different graphics tools and editing tools to support creating, manipulating, and editing digital images and graphics. In particular, the design system may be an AI-based design system that can leverage AI in various ways to provide enhanced functionality and provide users with advanced tools and features. For example, an AI-based design system can include a text-to-image model that takes an input natural language description and produces an image matching that description. AI-based design systems can manipulate and rearrange text and objects in images, and can correctly place design elements in novel compositions without explicit instructions.

### SUMMARY

Various aspects of the technology described herein are generally directed to systems, methods, and computer storage media for, among other things, providing font management using a font management engine in a design system. A design system provides graphics and editing tools for generating digital designs. The font management engine supports recommending fonts for designs associated with the design system. In particular, the font management engine generates font pair recommendations that include a heading font and a subheading font. A user can provide a prompt to generate a design and the font management engine identifies and ranks heading fonts, and pairs the ranked heading fonts with subheading fonts based on a font pairing algorithm. In this way, the font pairs are efficiently selected to complement each other and enhance an overall effectiveness and aesthetic appeal of a design, while ensuring readability and maintaining visual harmony.

The font management engine can refer to a component that supports generating font pair recommendations (i.e., a heading font and a subheading font) based on font management engine resources (e.g., operations, interfaces, and data). The font management engine includes and employs different components and techniques to identify, rank, select, and pair fonts in font pairing recommendation that include a heading font and a subheading font. In particular, balanced contrast similarity scores between visual embeddings of heading fonts and visual embeddings of subheading fonts are determined, and then further using the custom balance-contrast distance function for pairing fonts a font pair recommendation is identified. The font pair recommendation can be incorporated in an AI-generated design associated with a prompt from a user.

Conventionally, design systems are not configured with a comprehensive computing logic and infrastructure to efficiently and effectively recommend fonts for designs. For example, using an AI-based design system to make design decisions can be challenging because of the subjective nature of design choices for a user. A good font can make a design document interesting and engaging, while a bad font may break a good design. Selecting contextually relevant fonts can be challenging for an AI-based system. Moreover, selecting a pair of fonts (e.g., a heading font and a subheading font) for a design document can present even more challenges. Conventional design systems may simply manually map design intents to fonts. While mapping design intent to fonts can provide a structured approach to font selection, it also has limitations in terms of flexibility, context sensitivity, creativity, and scalability.

A technical solution—to the limitations of conventional design systems—can include providing font management resources via a font management system that supports font management in a design system. The font management resources can include LLM-generated font category descriptions for font categories, a font category to font mapping dataset, an LLM for determining prompt and font category similarity, font visual embeddings module for generating font visual embeddings, and font pairing module for recommending font pairs using heading font candidates and subheading font candidates based on a balance-contrast distance function. The font management resources can further include a weighted scoring mechanism, nearest neighbor approach and stratified sampling to rank the font pairs and bring novelty to the predictions.

In operation, in a first embodiment, font category descriptions are generated for font categories that are mapped to fonts. Font category embeddings for font category descriptions are generated. Prompt embeddings for a prompt are generated. Using the font category embeddings, the prompt embeddings, and font categories, at least one heading font candidate is identified. Using a font pairing operation, at least one subheading font candidate for the at least one heading font candidate is identified. At least one font pairing is identified. The at least one font pairing is identified based on the at least one font heading candidate and the at least one subheading font candidate. The at least one font pairing comprises a heading font and a subheading font.

In a second embodiment, font category embeddings for font category descriptions are accessed. The font category descriptions are associated with font categories that are mapped to fonts. A plurality of prompt embeddings for a prompt are accessed. Using the font category embeddings, the prompt embeddings, and the font categories, at least one heading font candidate is identified from the fonts that are mapped to the font categories.

In a third embodiment, at least one heading font candidate is identified. Using a font pairing operation, at least one subheading font candidate is identified for the at least one heading font. At least one font pairing is identified based on the at least one font heading candidate and the at least one subheading font candidate. The at least one font pairing comprises a heading font and a subheading font.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1A is a block diagram of an exemplary design system including a font management engine, in accordance with aspects of the technology described herein;

FIGS. 1B-1G are font management schematics associated with a font management workflow of a font management engine, in accordance with aspects of the technology described herein;

FIG. 2 is a flow diagram associated with an exemplary design system including a font management engine, in accordance with aspects of the technology described herein;

FIG. 3 provides a first exemplary method of providing font management using a font management engine, in accordance with aspects of the technology described herein;

FIG. 4 provides a second exemplary method of providing font management using a font management engine, in accordance with aspects of the technology described herein;

FIG. 5 provides a third exemplary method of providing font management using a font management engine, in accordance with aspects of the technology described herein;

FIG. 6 provides a block diagram of an exemplary design system suitable for use in implementing aspects of the technology described herein;

FIG. 7 provides a block diagram of an exemplary distributed computing environment suitable for use in implementing aspects of the technology described herein; and

FIG. 8 provides a block diagram of an exemplary computing environment suitable for use in implementing aspects of the technology described herein.

### DETAILED DESCRIPTION

### Overview

A design system is a comprehensive platform that provides tools and resources for creating, managing, and editing digital content, including graphics, layouts, and interactive elements. The design system streamlines the design process by offering features such as vector and raster editing, typography tools, color management, and collaborative capabilities, ensuring consistency and efficiency in producing high-quality visual materials. The design system can be an AI-based design system that leverages AI in various ways to provide enhanced functionality and provide users with advanced tools and features.

Using a design system or an AI-based design system to make design decisions can be challenging because of the subjective nature of design choices for a user. Nonetheless, a good font can make a design document interesting and engaging, while a bad font may break a good design. As such, selecting contextually relevant fonts can be challenging for an AI-based system—more over selecting a pair of fonts (e.g., a heading font and a subheading font) for a design document can present even more challenges.

Conventionally, design systems are not configured with a comprehensive computing logic and infrastructure to efficiently and effectively recommend fonts for designs. Selecting contextually relevant fonts can be challenging for an AI-based design system. For example, using an AI-based design system to make design decisions can be challenging because of the subjective nature of design choices for a user. A good font can make a design document interesting and engaging, while a bad font may break a good design. Moreover selecting a pair of fonts (e.g., a heading font and a subheading font) for a design document can present even more challenges. Conventional design systems may simply manually map design intents to fonts. While mapping design intent to fonts can provide a structured approach to font selection, it also has limitations in terms of flexibility, context sensitivity, creativity, and scalability. As such, a more comprehensive design system—with an alternative basis for performing font management operations—can improve computing operations and interfaces for design systems.

Embodiments of the present technical solution are directed to systems, methods, and computer storage media for, among other things, providing font management using a font management engine in a design system. A design system provides graphics and editing tools for generating digital designs. The font management engine supports recommending fonts for designs associated with the design system. In particular, the font management engine generates font pair recommendations that include a heading font and a subheading font. A user can provide a prompt to generate a design and the font management engine identifies and ranks heading fonts, and pairs the ranked heading fonts with subheading fonts based on a font pairing algorithm. In this way, the font pairs are efficiently selected to complement each other and enhance an overall effectiveness and aesthetic appeal of a design, while ensuring readability and maintain visual harmony.

At a high level, a font management engine operates to identify a font pair that includes a heading font and a subheading font. In summary, embedding representations of font category descriptions (i.e., font category embeddings) and a prompt (i.e., a prompt embedding) are generated. An embedding can refer to a learned representation of an object (e.g., a font) in a continuous, often lower-dimensional vector space. The vectors capture semantic meanings and relationships between the objects, enabling efficient and effective computations and analyses. A font category description provides a concise explanation of a specific group of fonts, highlighting their common characteristics, visual style, and typical use cases. A prompt (e.g., a user prompt) for a design can also be represented as an embedding. The font category embedding and prompt embedding can be represented in the same state-space.

Based on the font category embeddings and the prompt embedding, a top K font categories are retrieved based on a similarity evaluation (e.g., K-Nearest Neighbor-KNN cosine similarity). An overlap of fonts in the font categories can be used to rank fonts for heading fonts. Heading fonts (i.e., heading font candidates) are sampled from ranked fonts. In particular, a novelty algorithm is used to select font families and heading font candidates.

Next, a font pairing that includes a heading font and a subheading font is identified. Identifying font pairings can be based on font visual embeddings of fonts in a font repository. The font management engine includes visual representations of fonts (i.e., font visual embeddings) as font data. The font management engine can generate font visual embeddings of fonts using a vision-based machine learning model (e.g., vision transformer large model).

Heading font visual embeddings and subheading font visual embeddings that are identified are processed using a font pairing operation. In particular, balanced contrast similarity scores between the visual embeddings of heading font embeddings candidates and subheading visual embeddings candidates are calculated using a custom balance-contrast distance function for pairing fonts. The custom balance-contrast distance function supports determining better font pairs. A stroke width algorithm is used to ensure that the stroke width of a subheading font is less than a heading font. A font pairing is identified and provided to support generating a final design.

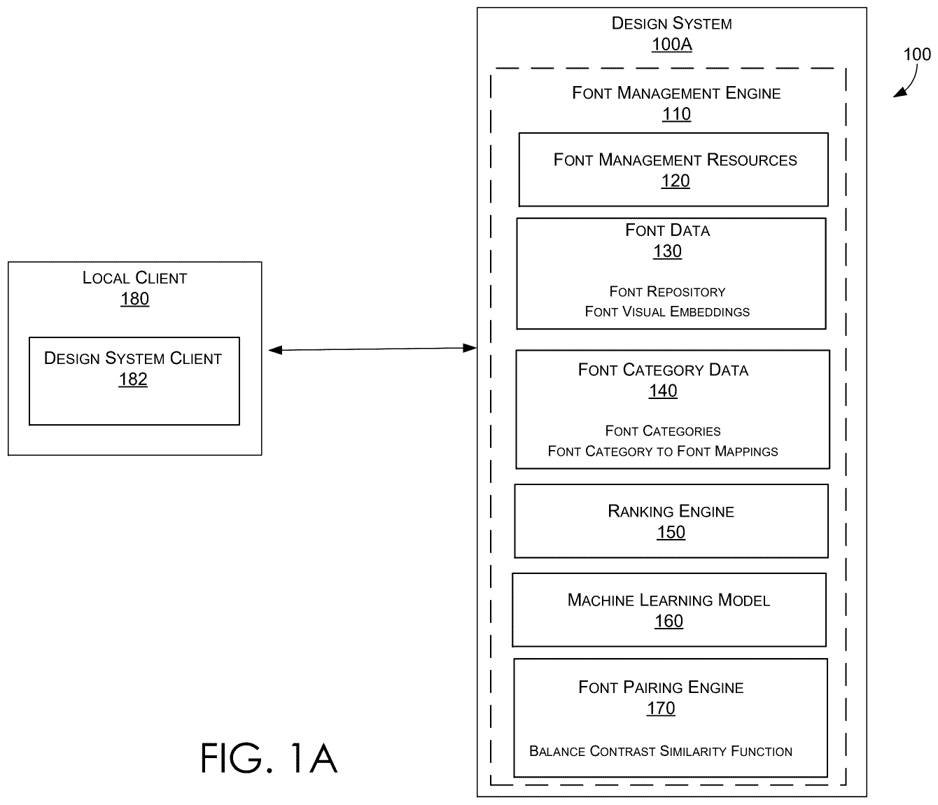

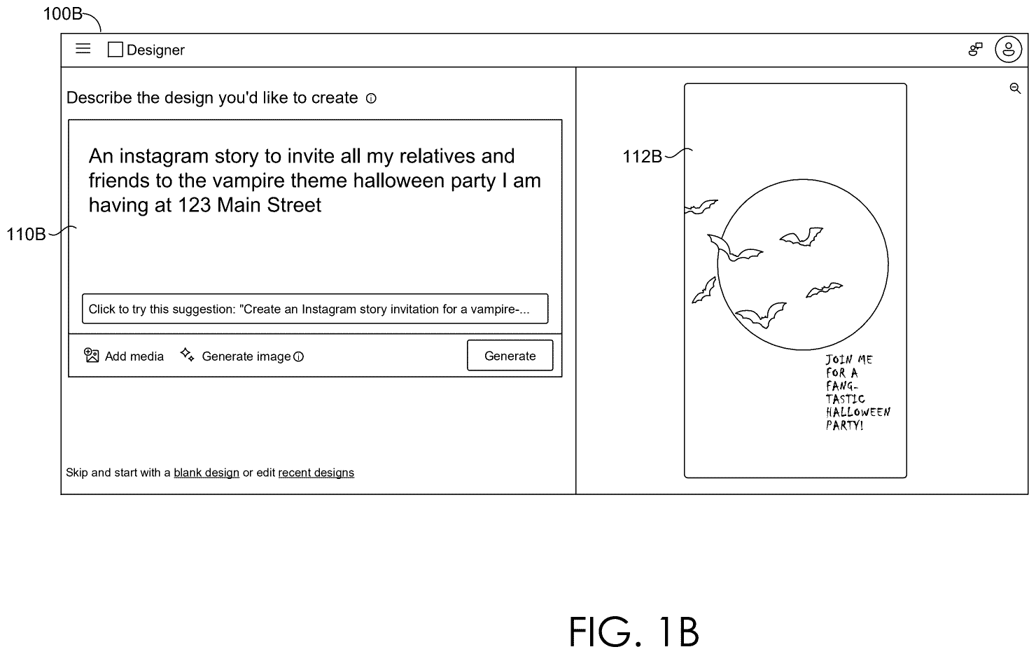

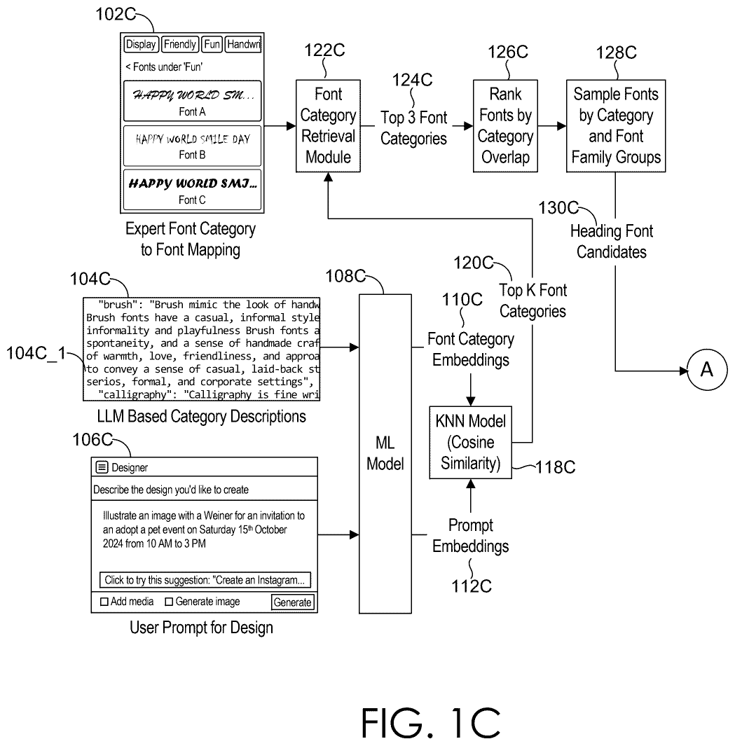

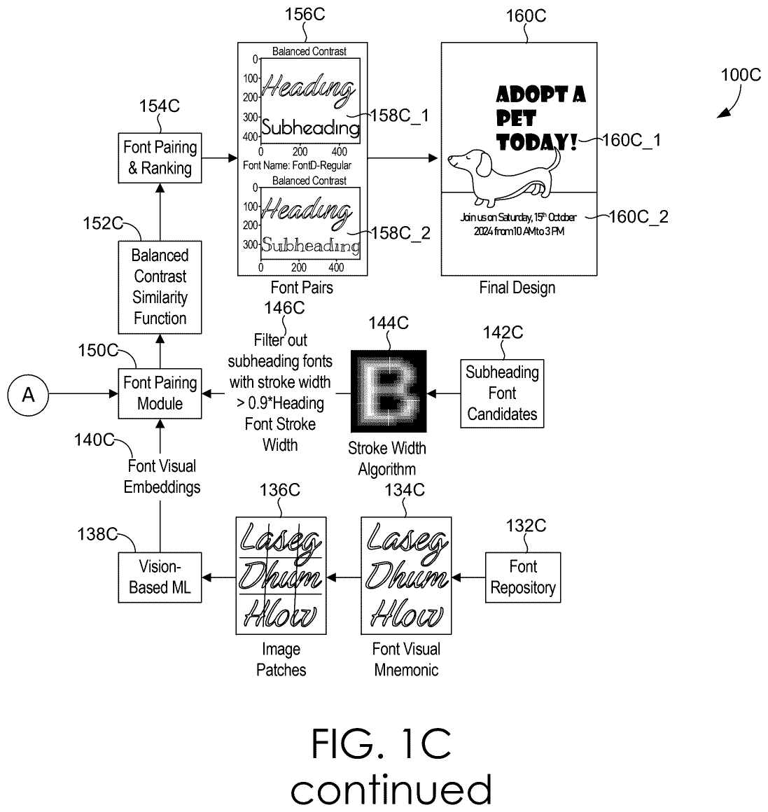

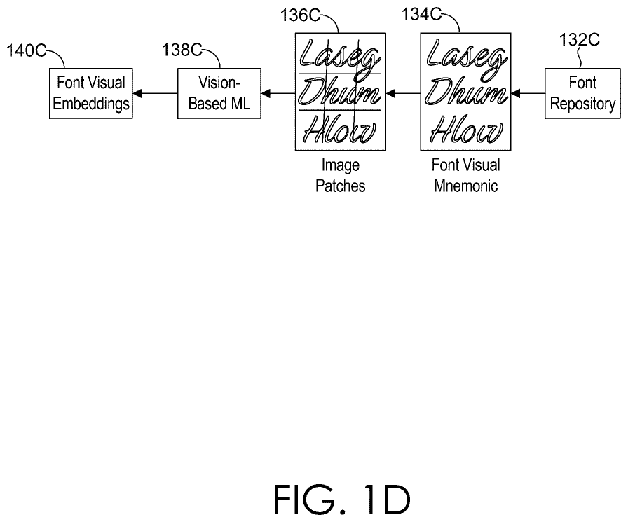

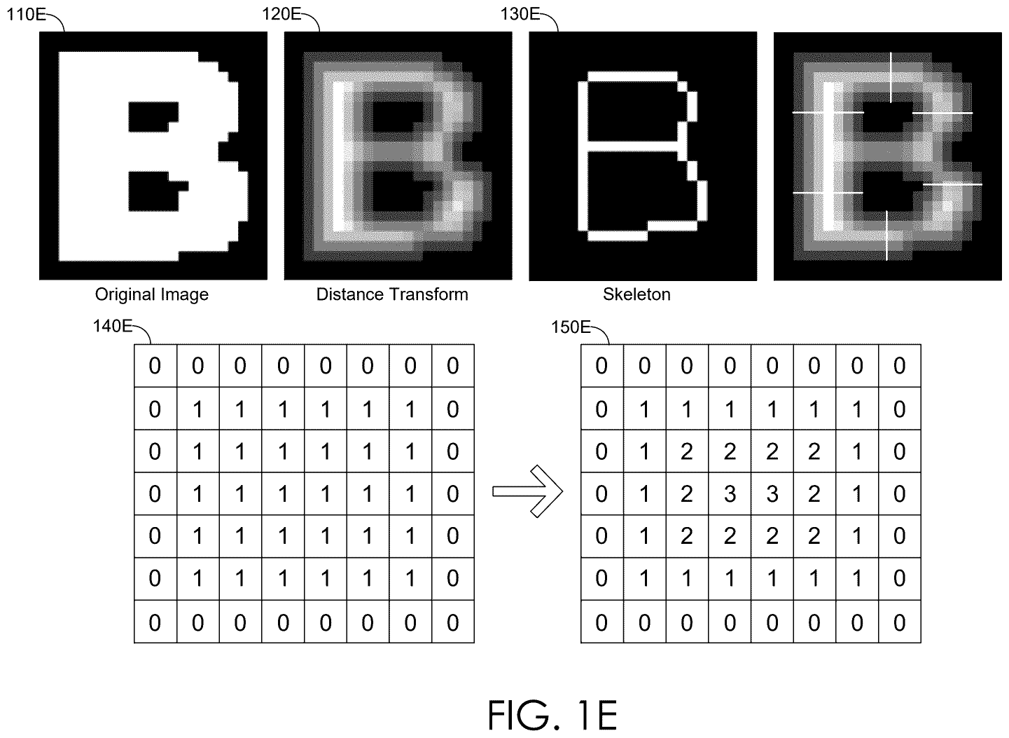

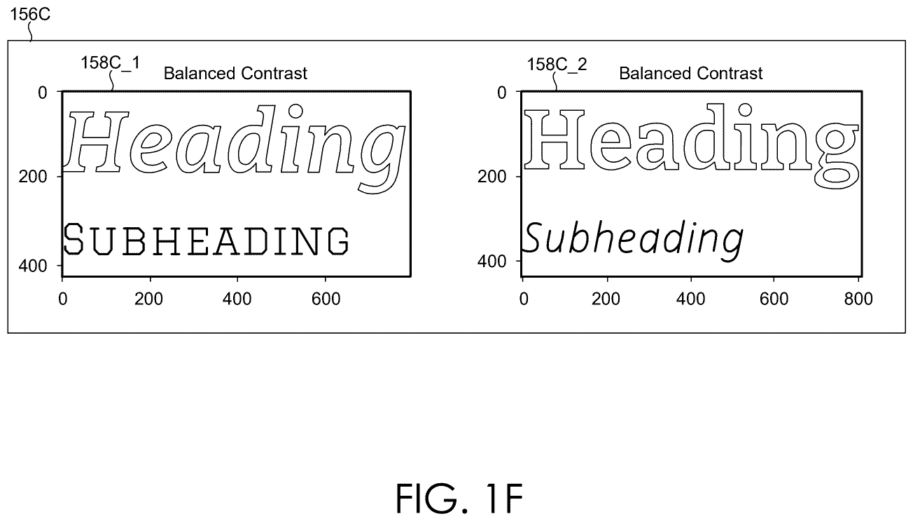

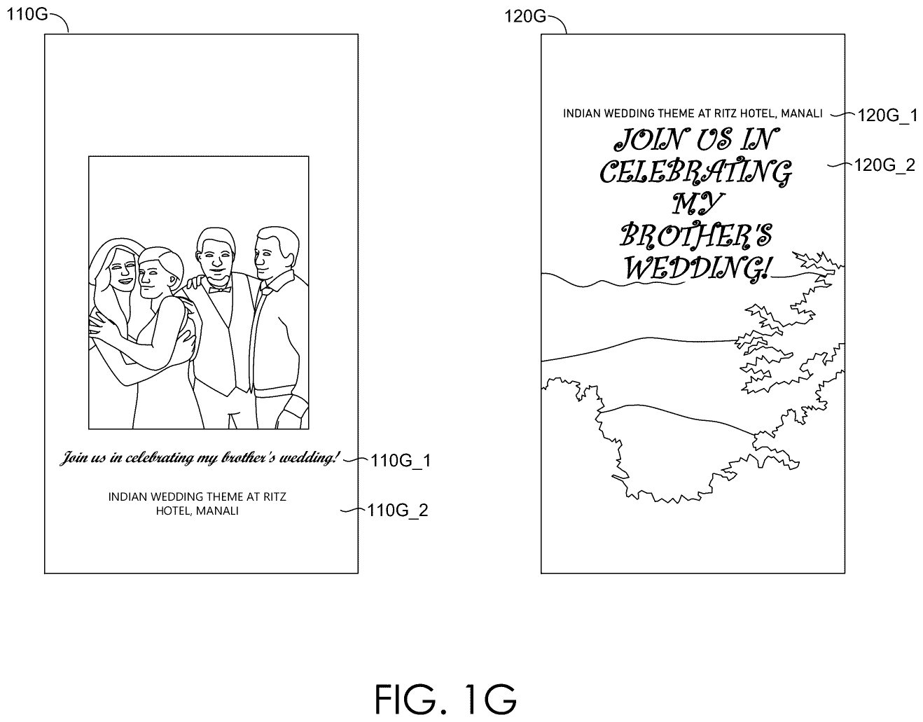

With reference to FIG. 1B, FIG. 1B illustrates an AI-based design system that provides an interface 100B to receive text 110B as input, so that the AI-based system (e.g., via an AI-based system service) produces an image 112B based on the input. By way of illustration, the generation of images from prompts entails several sequential steps: first, the AI-based design system ingests a textual prompt from the user, employing natural language processing (NLP) to extract key elements and context. Following this, a conceptual representation of the desired image is generated, outlining main components and their relationships. Leveraging advanced machine learning models like Generative Adversarial Networks (GANs), the AI-based design system synthesizes the image, drawing from vast datasets to produce realistic visuals. Iterative refinement stages may follow, adjusting details and styles to closely align with the prompt. Ultimately, the finalized image is rendered and presented to the user, with options for further customization. Throughout this process, the AI-based design system effectively combines linguistic understanding with visual synthesis capabilities to generate tailored and high-quality images based on user input.

In some embodiments, the AI-based design system may operate based on an AI-based design service “design service.” The design service acts as a critical intermediary, ensuring efficient, context-aware font recommendations from the font management engine are seamlessly integrated into the AI-based design system, enhancing the overall design process and user experience. For example, a user inputs a prompt into the AI-based design system, requesting an AI-generated image for a tech company's marketing material. The design service receives this request and analyzes the context. It queries the font management engine, which returns a list of suitable fonts. The design service then presents these options within the AI-based design system's interface, allowing the designer to preview and select the best fit. Alternative, AI-based design system may select one or more font pairs to generate one or more AI-generated images based on the prompt.

With reference to FIG. 1C, FIG. 1C illustrates an end-to-end schematic 100C of functionality associated with a design system and a font management engine to support providing font pairings for images (e.g., AI-generated images). Font categories 102C can be manually and/or automatically generated. For example, a typography expert can support font mapping (e.g., expert font category to font mapping). The expert may identify a combination of moods represent by fonts, their look, and other attributes. The font categories 102C may also be automatically generated in some instances, using a machine learning model to categorize font. Font categories 102C can be named (e.g., fun, cute, friendly, elegant, and modern). Font categories 102C can further include fonts that are tagged to different font categories manually or automatically. Fonts can be tagged to two or more categories. For example, a font could be modern and friendly at the same time.

Font category descriptions 104C can be generated using a machine learning model 104C_1 (e.g., an LLM-based category descriptions). The machine learning model 104C_1 can generate font category description 104C details including history, mood, and design preferences for each font category. Font category descriptions 104C can further be manually curated. For example, a typography expert or designer may modify a font category description 104C to refine the details of the font category description.

The following is an example prompt for the machine learning model 104C_1. What are [font category name] typefaces or [font category name] fonts category? Where are they commonly used today, or used in the past? What emotions do they evoke? In which context are [font category name] category fonts suitable for usage, and in which context [font category name] category fonts should be avoided? Give your response in a crisp manner that's suitable for creating an embedding of your response using a large language model.

A machine learning model 108C (e.g., Mini LM V2 6-layer model) can be pre-trained for sentence similarity. The font category descriptions (e.g., font category description 104C) and the prompts (e.g., prompt 106C) can be processed via the machine learning model 108C to generate corresponding embeddings (i.e., font category embeddings 110C and prompt embedding 112C). Sentence similarity can be be determined based on encoding meaning and context of input sentences into vector representations. These representations capture semantic similarities between sentences, allowing the machine learning model 108C to measure the similarity between them using various distance metrics (e.g., cosine similarity or Euclidean distance). A prompt (e.g., prompt 106C) can be processed at the machine learning model 108C. For example, a user enters a prompt to generate a design. The prompt can be entered via a user interface of the AI-based design system. The prompt is communicated to the machine learning model machine learning model 108C to generate a prompt embedding at run time. In some embodiments, prompts may be automatically generated without user intervention (e.g., via an automated prompting system configured to automatically generate prompts to identify different types of font pairings).

The font embeddings 110C and prompt embedding 112C can be used to identify a subset of font categories (e.g., top K font categories 120C) associated with the prompt 106C. The top K categories 120C (e.g., top 3) can be retrieved using a KNN approach (e.g., KNN model 118C) with K as 3 and distance metric as cosine similarity. For example, top 3 categories identified can be Fun, Friendly, and Cute. It is contemplated that the font management engine can implement different functional components or models (e.g., ML model, KNN model 118C, font category retrieval module 122C, rank fonts by category overlap 126C, sample fonts by category and font family groups) to perform functionality described herein. For the font category retrieval module 122C retrieves the top K font categories 124C from category data (i.e., font category to font mapping 102C) and the ranks fonts by category overall 126C ranks heading fonts based on an overlap approach.

By way of illustration, a user prompt may be: “a design for wedding invitation”; and the retrieved fonts categories may be: Wedding, Cursive, and Elegant.

Fonts that are mapped to these font categories are identified. For example:
Wedding_Cursive: Font A, Font B;
Wedding_Elegant: Font C, Font D;
Wedding_Cursive_Elegant: Font E, Font F;
Wedding: Font G.

### With Font Ranking: Font E, Font F, Font A, Font B, Font C, Font D, Font G.

A novelty approach (e.g., sample fonts by category and font family groups 128C) can be implemented for sampling from each category. The novelty approach for selecting a sample of fonts can include prioritizing or favoring selecting fonts that are different or unique compared to those already present in the sample. For example, a novel sample can include a sample from each category:
Wedding_Cursive_Elegant: Font E;
Wedding_Cursive: Font A;
Wedding_Elegant: Font C;
Wedding: Font G.
   As illustrated, the sample fonts by category and font family groups 128C functionality identifies at least one heading font candidate (e.g., heading font candidates 130C).

With reference to FIG. 1D, FIG. 1D focuses on a sub-portion of FIG. 1C that illustrates generating font visual embeddings. Font visual embeddings 140C are obtained by inferring font mnemonic images (i.e., Laseg Dhum Hloiv 136C image patches) consisting of mnemonic text ‘Laseg Dhum Hloiv’ (i.e., Laseg Dhum Hloiv 134C font visual mnemonic) on a vision-based machine learning model 138C (e.g., a Visual Transformer “ViT” model). The mnemonic text is communicated to a font or text rendering engine (e.g., OpenCV FreeType) where text functions employed to render the mnemonic image for each font. Then the images are communicated into the vision-based machine learning model 138C to generate the visual embeddings for each font. Visual embeddings and fonts in font repository 132C can be generally referred to as font data of fonts that are processed and paired as heading fonts and subheading fonts as described herein.

With reference to FIG. 1E, FIG. 1E illustrates a font visual representation associated with determining a stroke width attribute for fonts. For example, for a selected font, font visual representations in a font size (e.g., font size 50) across all fonts can be generated, and a distance transform operation and skeletonize operation can be used to determine the stroke width of every font in the font repository. In this way, a font can have an original image 110E, a distance transform image 120E, a skeleton image 130E. By way of illustration, the binary visual image (e.g., binary visual image 140E) of a font alphabet can be first converted to a distance transform version (e.g., distance visual image 150E) to determine pixel wise thickness. Then skeletonization of the input image is done to find the central pixel. Then the stroke width is determined by multiplying the distance between center pixels and edges by 2.

As shown in FIG. 1C, subheading font candidates 142C can be fonts in the font repository 132C that are not heading font candidates. The stroke width algorithm 144C is used to determine stroke width of subheading font candidates. A filter 146C can be employed to filter out subheading fonts based on a predefined criteria. For example, subheading fonts with stroke width>factor*heading font stroke width. The factor is provided as a multiplier (e.g., factor=0.8 or 0.9) for a stroke width algorithm. Other variations and combinations of criteria for filing out subheading font candidates are contemplated with embodiments described. The font pairing model 150C can be configured to select subheading font candidates based on a font pairing operation and font pairing algorithm, as discussed below.

With continued reference to FIG. 1C, subheading fonts are selected using font pairing module 150C and a font pairing algorithm. The font pairing algorithm (e.g., custom balance-contrast distance function 152C) introduces a balanced contrast-similarity metric between visual embeddings of fonts to discover font pairings. A balance contrast similarity score can refer to a metric that quantifies the degree of similarity between fonts based on their visual balance and contrast, in order to ensure aesthetic harmony in design. This score is calculated by extracting and normalizing features related to balance and contrast, computing the differences between corresponding features of the elements being compared, and aggregating these differences into a single score. In this way, a calculated score indicates similarity in balance and contrast.

By way of illustration, input into the font pairing module 150C can include: Font Visual Embeddings 140C, Fonts Stroke Width, Heading Font Candidates 130C.

At step 1: Given the current selected heading font is f and there are k different subheading font candidates, then m out of those k candidates are selected on basis of rule: Stroke Width (Subheading Font j)<=0.8*Stroke Width (Heading Font f)

At step 2: Given that A is the visual embedding of font selected for heading and B is the visual embedding for the subheading font candidate. Then for j^{th} subheading candidate:

$${P}_{j} = {\sum }_{i = 1}^{n} {A}_{i} {B}_{i} ( where {A}_{i} {B}_{i} > 0 )$$

$${N}_{j} = - {\sum }_{i = 1}^{n} {A}_{i} {B}_{i} ( where {A}_{i} {B}_{i} < 0 )$$

At step 3: Suppose there are m font candidates for subheading for the given heading font, we do min max normalization of positive and negative scores for all m subheading candidates. Suppose P is the tensor of positive scores across all m candidates and N is the tensor of negative scores:

$${P}_{norm} = MinMaxNorm ( P )$$

$${N}_{norm} = MinMaxNorm ( N )$$

At step 4: Out of the m candidates, the candidates which have a balance of negative and positive traits in terms of visual similarity with selected font are retained. This is done by:

$$\begin{matrix}{P}_{46} = & \{ {P}_{norm} if {P}_{norm} \geq {Perc}_{40} ( {P}_{norm} ) \& {P}_{norm} \leq {Perc}_{60} ( {P}_{norm} ) else \\ & \{ 0\end{matrix}$$

$$\begin{matrix}{N}_{46} = & \{ {N}_{norm} if {N}_{norm} \geq {Perc}_{40} ( {N}_{norm} ) \& {N}_{norm} \leq {Perc}_{60} ( {N}_{norm} ) else \\ & \{ 0\end{matrix}$$

Final score is determined using: Balanced Contrast Similarity Score=P₄₆·N₄₆

At step 5: subheading fonts are selected in decreasing order of balanced contrast similarity score. Font pairing and font ranking 154C supports ranking font pairs (e.g., font pairs 156) based on balanced contrast similarity scores. Font pair 158C_1 and font pair 158C_2 can be ranked based their corresponding balanced contrast similarity scores. As shown in FIG. 1F, FIG. 1F illustrates example font pairings 156C with font pair 158C_1 and font pair 158C_2 output examples.

With reference to 1G, FIG. 1G illustrates output of an AI-based design system that generates example AI-generated images (i.e., wedding invitation AI image 110G and wedding invitation AI image 120G) based on a user prompt for a wedding invitation Wedding invitation AI image 110G includes a first heading font 110G_1 and a first subheading font 110G_2; and Wedding invitation AI image 120G includes a second heading font 120G_1 and a second subheading font 120G_2 for a second image based on the user's prompt (i.e., “a design for wedding invitation”). As shown in FIG. 1C, the prompt 106C can be used to automatically generate an AI image 160C with a font pair including heading font 160C_1 and subheading font 160C_2.

Advantageously, the embodiments of the present technical solution include several inventive features (e.g., operations, systems, engines, and components) associated with a design system having a font management engine. The font management engine supports recommending fonts for designs associated with the design system. In particular, the font management engine generates font pair recommendations that include a heading font and a subheading font. Balanced contrast similarity scores between visual embeddings of heading fonts and visual embeddings of subheading fonts are determined, and then further using the custom balance-contrast distance function for pairing fonts a font pair recommendation is identified. The font pair recommendation can be incorporated AI-generated design associated with a prompt from a user. Moreover, the font pairs (i.e., a heading font and a subheading font) can be used to automatically generate one or more AI-generated images that are communicated to client associated with a user and caused to be displayed. In this way, the font pairs are efficiently selected to complement each other and enhance an overall effectiveness and aesthetic appeal of a design, while ensuring readability and maintain visual harmony.

### Example Systems and Resources

Aspects of the technical solution can be described by way of examples and with reference to FIGS. 1A-1G. FIG. 1A illustrates a cloud computing environment (system) 100, design system 100A; font management resources 120, font data 130, font category data 140, ranking engine 150, machine learning model 160, font pairing engine 170, local client 180 and design system client 182.

The cloud computing system 100 provides a computing environment for implementing design system 100A. Design system 100 provides graphics tools and editing tool and other design system resources to support creating, manipulating, and editing digital images and graphics. The design system 100A may be an AI-based design system that can leverage AI in various ways to provide enhanced functionality and provide user with advance tools and features. The design system 100A includes font management engine 100 that provides font management for recommending fonts for designs associated with the design system 100A.

The font management engine 110 provides font management using font management resources 120. Font management resources 120 include operations, interfaces, and data the enable providing font pairings. For example, the operations can include data ingestion, semantic understanding, feature extractions, similarity and diversity metrics, and a font pairing algorithm; the interfaces can include user interfaces associated with font recommendations and font pairings, Application Programming Interfaces (APIs) and integration interfaces; and data includes font category data, font categories, font category-to-font mappings; font metadata, font repository and font visual embeddings.

Font management engine 110 generates font category descriptions for font categories that are mapped to fonts. For example, the font management engine 110 can include, access, or support generating font category data 140 that includes a curated instance of font categories descriptions and font categories that are mapped to fonts. In some embodiments, font management engine 110 may access predefined instance of font category descriptions that are mapped to fonts. In this way, the font category data 140 can include font categories, font category descriptions, and font categories that are mapped to fonts. Font data 130 can include a font repository, font metadata, and font visual embeddings that are generated for fonts.

Font management engine 110 includes a machine learning model 160. The machine learning model 160 can be a large language model (LLM). The machine learning model 160 generates font category embeddings for the font category descriptions and generates prompt embeddings for a prompt. The prompt can be a user prompt that is provided via a design system interface associated with generating artificial-intelligence-based designs. Prompts may be automatically generated without user intervention.

The font management engine 110—using the font category embeddings, the prompt embeddings, and the font categories—identifies at least one heading font candidate. The font management engine 110 identifies the at least one heading font candidate is based on: calculating a similarity between the font category embeddings and the prompt embeddings and retrieving a plurality of top font categories upon calculating the similarity between the font category embeddings and the prompt embeddings. The font management engine 110 calculates the similarity between the font category embeddings and the prompt embedding based on a k-nearest neighbors algorithm (KNN). The font management engine 110 further maps the prompt embeddings with the font category embeddings to determine the plurality of top font categories based on an overlap between the font category embeddings and the prompt embeddings.

The at least one heading font candidate is further identified based on: using the font categories that are mapped to the fonts. The font management engine 110 retrieves each font associated the plurality of top font categories, ranks each font within the plurality of top font categories based on overlap across each font within the plurality of top font categories, and determines the at least one heading font candidate based on the ranking of each font within the plurality of top font categories. Ranking each font within the plurality of top font categories can be performed using the ranking engine 150. The ranking engine 150 can be configured to perform other ranking operations for the font management engine 110 as described herein.

The font management engine 110 uses a font pairing operation to identify at least one subheading font candidate for the at least one heading font candidate. The font management engine 110 identifies the at least one subheading font candidate based on font visual embeddings, where the font visual embeddings are associated with corresponding fonts. The font visual embeddings support matching the heading font candidates to subheading font candidates based on a balance contrast similarity function. The font management engine 110 identifies the at least one subheading font candidate based on additional operations that include: filtering through subheading font candidates based on stroke width; and removing a plurality of subheading font candidates with stroke width greater than a threshold value. The threshold value is a percentage of the stroke width of the at least one heading font candidate. The stroke width can be determined based on a distance transform operation, a skeletonize operation, and binary visual representations of a font alphabet.

The font management engine 110 includes a font pairing engine 170. Font paring engine 170 supports a font pairing operation that is associated with a balance contrast similarity function, font visual embeddings, font stroke width, and font heading candidates to identify corresponding font subheading candidates. The font pairing engine 170 identifies at least one font pairing based on the at least one font heading candidate and the at least one subheading font candidate, the font pairing comprising a heading font and a subheading font.

The font pairing engine 170 identifies the at least one font pairing based on additional operations that include: determining similar features of the at least one heading font candidate and the at least one subheading font candidate; determining different features of the at least one heading font candidate and the at least one subheading font candidate; ranking (e.g., via ranking engine 150) a plurality of font pairs of heading font candidates and subheading font candidates based on a balanced contrast similarity function; and identifying a font pair with a highest ranking from the plurality of font pairs as the at least one font pairing.

The local client 180 includes design system client 182 that provides access and supports functionality associated with the design system 100A and font management engine 110. The design system client 182 can provide a design system interface for interacting with the design system 100A and accessing output associated with the font management engine 110. The design system client 182 can receive a user prompt and communicate the user prompt to cause generation of an AI-based image based on the user prompt. The user prompt may be processed via the design system (e.g., a design system service) that employs the font management engine 110 to identify a font pairing that can be used to generate the AI-based image. The AI-based image that includes the font pair can be communicated to the design system client 182 that causes generation of the AI-based image. It is contemplated that the design system client may include a user interface that queries the font management engine 110 for font recommendations (e.g., heading fonts, subheading fonts, and font pairings) based on a user prompt. One or more font recommendations can be communicated to the design system client 182 to cause generation of the font recommendations. The design system client 182 can include an interface for selecting one or more fonts from the font recommendations to be employed in different types of design tasks.

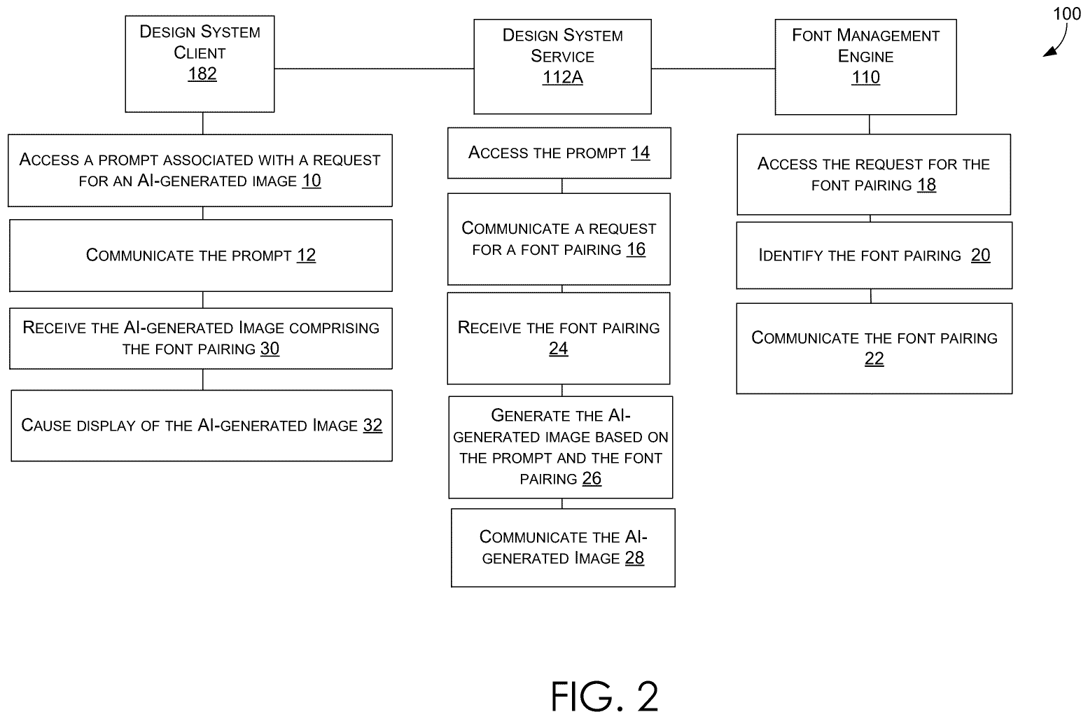

With reference to FIG. 2, FIG. 2 illustrates a cloud computing system 100 having design system client 182, design system service 112A, and font management engine 110. At block 10, the design system client 182 accesses a prompt associated with a request for an AI-generated image; and at block 12, communicates the prompt to the design system client.

At block 14, the design system service 112A accesses the prompt; and at block 16, communicates a request for a font pairing to the font management engine 110. At block 18, the font management engine 110 accesses the request for the font pairing; at block 20, identifies the font pairing; at block 22, communicates the font pairing to the design system service 112.

At block 24, the design system service 112A receives the font pairing; at block 26, generates the AI-generated image based on the prompt and the font pairing; at block 28, communicates the AI-generated image. At block 30, the design system client 182 receives the AI-generated image comprising the font pairing; and at block 32, causes display of the AI-generated image.

The scenario described above is meant to be an example implementation of the font management engine 110, where the font management engine 110 operates with a design system service 112A and design system client 812. In particular, the font management engine 110 receives a request, from the design system service 112A, for a font pairing, and then communicates the font pairing to the design system service 112A that generates an image with the font pairing and communicates the image to the design system client 182. It is contemplated that the font management engine 110 can receive requests for font pairings or individual fonts (e.g., a heading font, subheading font) from different types of services and applications (e.g., Word Process or Presentation Programs) that utilize fonts, and then the font management engine 110 communicates an output to the service based on the request. Other variations and combinations of services and requests associated with the font management engine are contemplated with embodiments described herein

### Example Methods

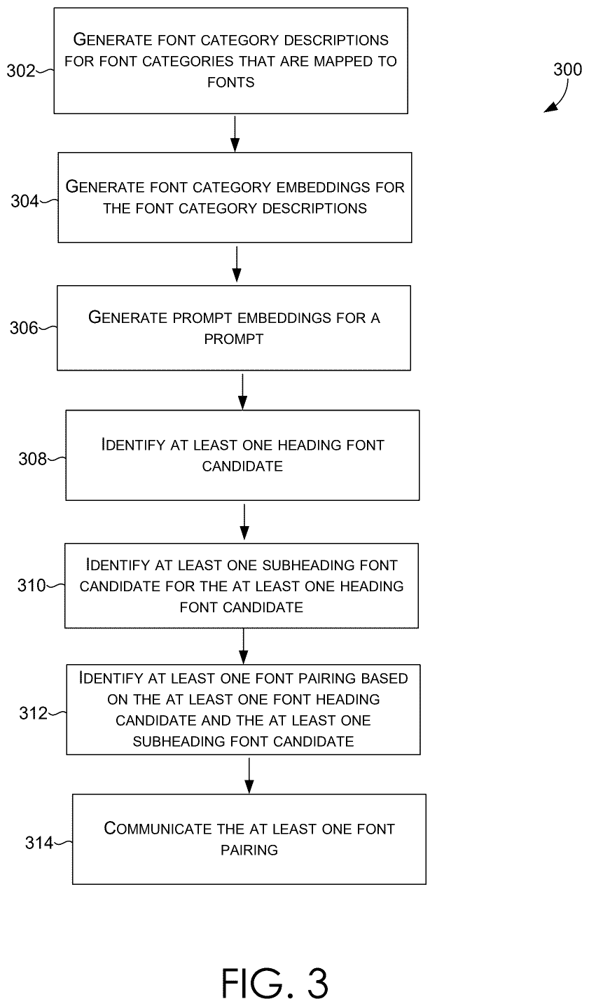

With reference to FIGS. 3, 4, and 5, flow diagrams are provided illustrating methods for providing font management using a font management engine in a design system. The methods may be performed using the design system described herein. In embodiments, one or more computer-storage media having computer-executable or computer-useable instructions embodied thereon that, when executed, by one or more processors can cause the one or more processors to perform the methods (e.g., computer-implemented method) in the design system (e.g., a computerized system).

Turning to FIG. 3, a flow diagram is provided that illustrates a method 300 for providing font management using a font management engine in a design system. At block 302, generate font category descriptions for font categories that are mapped to fonts. At block 304, generate font category embeddings for the font category descriptions. At block 306, generate prompt embeddings for a prompt. At block 308, identify at least one heading font candidate, using the font category embeddings. At block 310, identify at least one subheading font candidate for the at least one heading font candidate, using a font pairing operation. At block 312, identify at least one font pairing based on the at least one font heading candidate and the at least one subheading font candidate, the at least one font pairing comprising a heading font and a subheading font. At block 314, communicate the at least one font pairing.

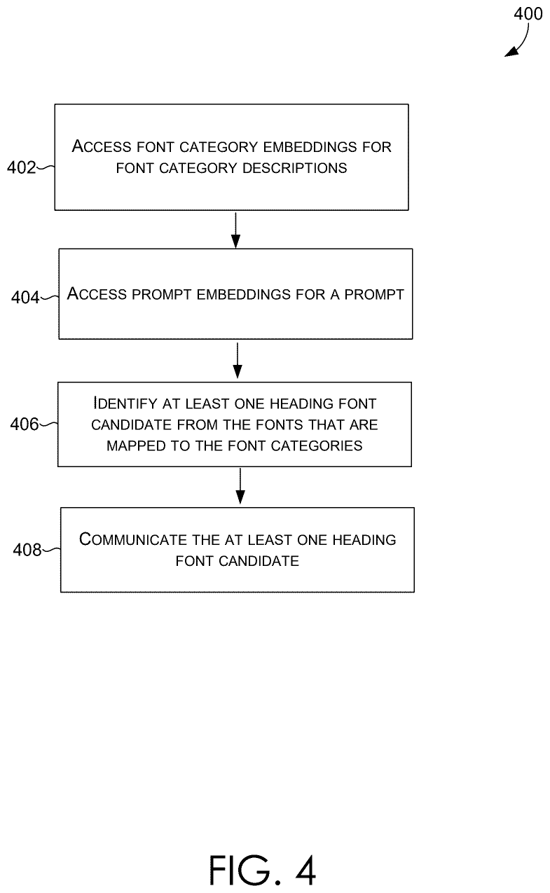

Turning to FIG. 4, a flow diagram is provided that illustrates a method 400 for providing font management using a font management engine in a design system. At block 402, access font category embeddings for font category descriptions, the font category descriptions are associated with font categories that are mapped to fonts. At block 404, access prompt embeddings for a prompt. At block 406, identify at least one heading font candidate from the fonts that are mapped to the font categories. At block 408, communicate the at least one heading font candidate.

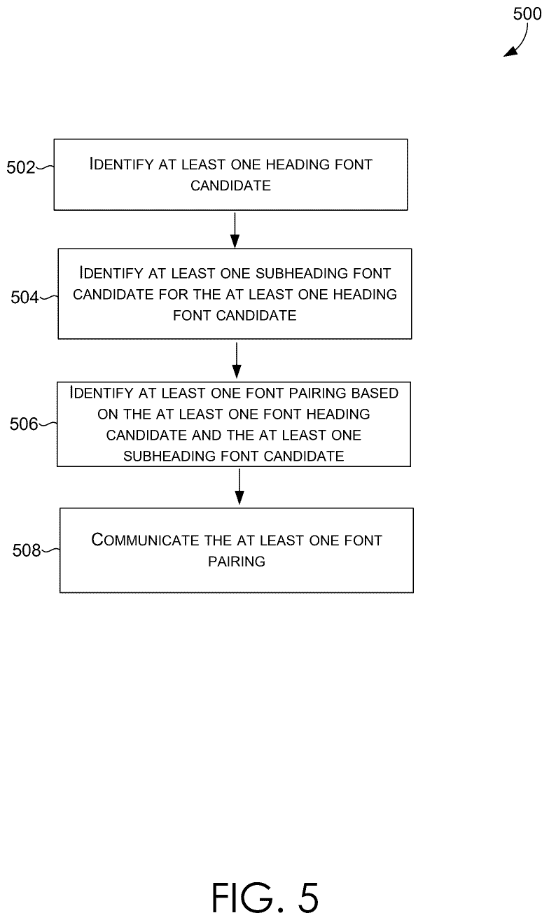

Turning to FIG. 5, a flow diagram is provided that illustrates a method 500 for providing font management using a font management engine in a design system. At block 502, identifying at least one heading font candidate. At block 504, identifying at least one subheading font candidate for the at least one heading font candidate, using a font pairing operation. At block 506, identify at least one font pairing based on the at least one font heading candidate and the at least one subheading font candidate, the font pairing comprising a heading font and a subheading font. At block 508, communicate the at least one font pairing.

### Technical Improvement

Embodiments of the present techniques have been described with reference to several inventive features (e.g., operations, systems, engines, and components) associated with a design system. Inventive features described include: operations, interfaces, data structures, and arrangements of computing resources associated with providing the functionality described herein relative with reference to a font management engine. Functionality of the embodiments of the present invention have further been described, by way of an implementation and anecdotal examples—to demonstrate that the operations for providing the font management engine as a solution to a specific problem in device management technology to improve computing operations in design systems.

By way of example, the font management engine supports recommending fonts for designs associated with the design system. In particular, the font management engine generates font pair recommendations that include a heading font and a subheading font. Balanced contrast similarity scores between visual embeddings of heading fonts and visual embeddings of subheading fonts are determined, and then further using the custom balance-contrast distance function for pairing fonts a font pair recommendation is identified. The font pairing can be incorporated into AI-generated design associated with a prompt from a user. Moreover, the font pairs (i.e., a heading font and a subheading font) can be used to automatically generate one or more AI-generated images that are communicated to client associated with a user and caused to be displayed. In this way, the font pairs are efficiently selected to complement each other and enhance an overall effectiveness and aesthetic appeal of a design, while ensuring readability and maintain visual harmony.

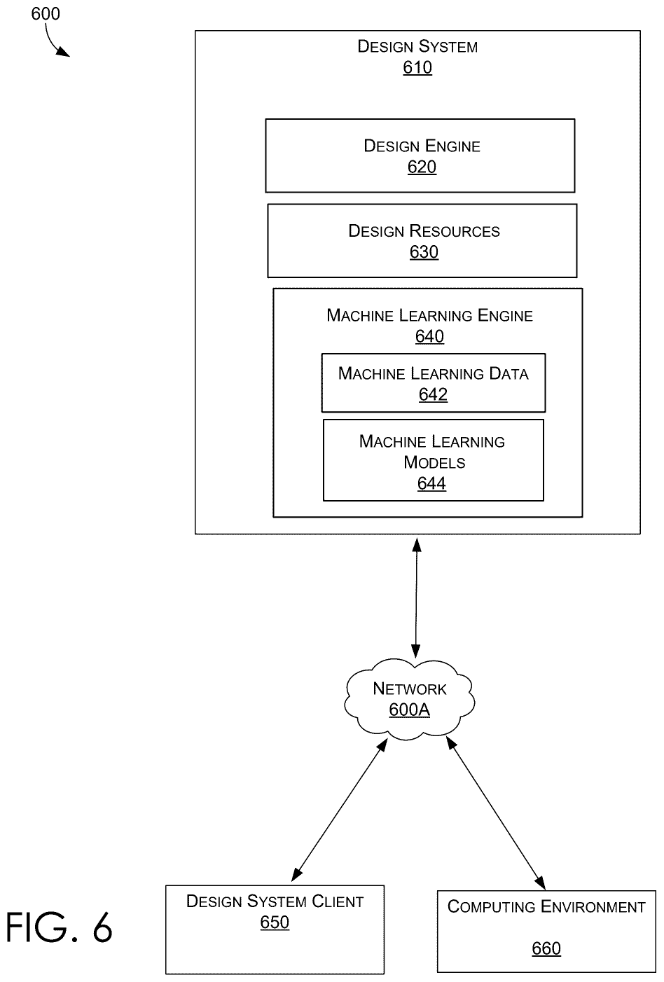

Aspects of the technical solution have been described by way of examples and with reference to FIGS. 1A, 1B, 1C, 2 and 2. FIG. 1A is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 1A illustrates a high level architecture of the cloud computing system 100 in accordance with implementations of the present disclosure, among other engines, managers, generators, selectors, or components not shown (collectively referred to herein as “components”).

### Additional Support for Detailed Description

### Example Design System in a Computing Environment

Referring now to FIG. 6, FIG. 6 illustrates a computing environment in which implementations of the present disclosure may be employed. In particular, FIG. 6 shows a high level architecture of an example cloud computing platform 600 and design system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing platform 600 provides computing system resources for different types of managed computing environments. For example, the cloud computing platform supports delivery of computing services-including compute, servers, storage, databases, networking, and intelligence. The components of cloud computing environment 600 may communicate with each other over a network 600A which may include, without limitation, one or more local area networks (LANs) and/or wide area networks (WANs).

The cloud computing platform 600 provides the foundational infrastructure and resources for a design system (e.g., design system 610) including AI-based design tools, to enable scalable, flexible, and powerful resources for creating, manipulating, and editing digital images and graphics. Cloud computing platform 600 leverages high-performance servers equipped with GPUs and TPUs to accelerate rendering and AI-driven tasks. Scalable storage solutions such as object storage handle vast libraries of design assets, while fast-access SSD storage caters to active data processing needs. Cloud computing platform 600 ensures efficient data transfer through high-speed, low-latency networking infrastructure. Cloud computing platform 600 integrates managed AI services for tasks like automated image enhancement and design suggestions, while robust data processing pipelines facilitate the handling of large datasets.

The design system 610 provides a comprehensive platform offering a suite of tools for creating, manipulating, and editing digital images and graphics. Design system 610 includes essential graphics tools like vector and raster editors, text tools, and advanced editing capabilities for intricate manipulations. AI-driven features enhance the system, providing automated image enhancements, design suggestions, and content generation based on user prompts. Natural language processing allows the system to interpret user inputs and generate relevant design elements. The user-friendly interface supports real-time collaboration and customization, while web-based dashboards enable interactive design input, preview, and feedback. Integration with other software is facilitated through RESTful APIs and SDKs, and the cloud infrastructure ensures high availability, scalability, and performance, dynamically allocating resources based on demand.

The design system 610 includes a design engine 620 that is a computing environment that supports executing computational tasks associated with the design system 610. The design engine 620 can be a hardware or software component that performs computational operations, such as, mathematical calculations, data processing, and algorithm execution. The design system 610 integrates design resources 630 into design system 610 to effectively provide computing functionality in a computing environment.

The design resources 630 refer to computing elements (e.g., components, capability, or entities) that collectively enable the design engine 620 operations. The design resources 630 encompass a spectrum of computing elements, beginning with the diverse operations the design resources 630 can perform, ranging from complex computations to data manipulations. Interfaces, an integral part of the design resources 630, provide the means for both user interaction and seamless integration with external systems, ensuring a dynamic and interactive computing experience. The data facet of the data design resources 630 involves various types: input data, which is the information provided for processing; processing data, representing the data manipulated during computational tasks; and output data, the results generated by the design engine 620. In this way, the design resources 630 support the broader design engine 620 and design system 610.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 140 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The design system client 650 supports access to design system 610. The design system client 650 can be provided as a user client or an administrator client to support user and administrator functionality associated with the computing environment 660, design engine 620, or design system 610. The design system client 650 can also support accessing computing visualizations and causing display of the computing visualization. The design system client 650 supports receiving computing information associated design engine 620 output from the design system 610 and causing presentation of the computing information. The computing information can specifically include computing visualizations associated with the design engine 620 output.

Computing environment 660 is a computing environment that is integrated into the design system 610. The computing environment 660 is characterized by an infrastructure, where data from various sources within the ecosystem, including servers, networks, applications, sensors, and user interactions, can be aggregated and processed by the design system 610 to perform computing tasks. The computing environment 660 can be associated with middleware and integration layers facilitate seamless data flow, while computing infrastructure, encompassing cloud-based resources, distributed computing frameworks, and optimized storage systems, supports functionality associated with the computing.

### Example Distributed Computing System Environment

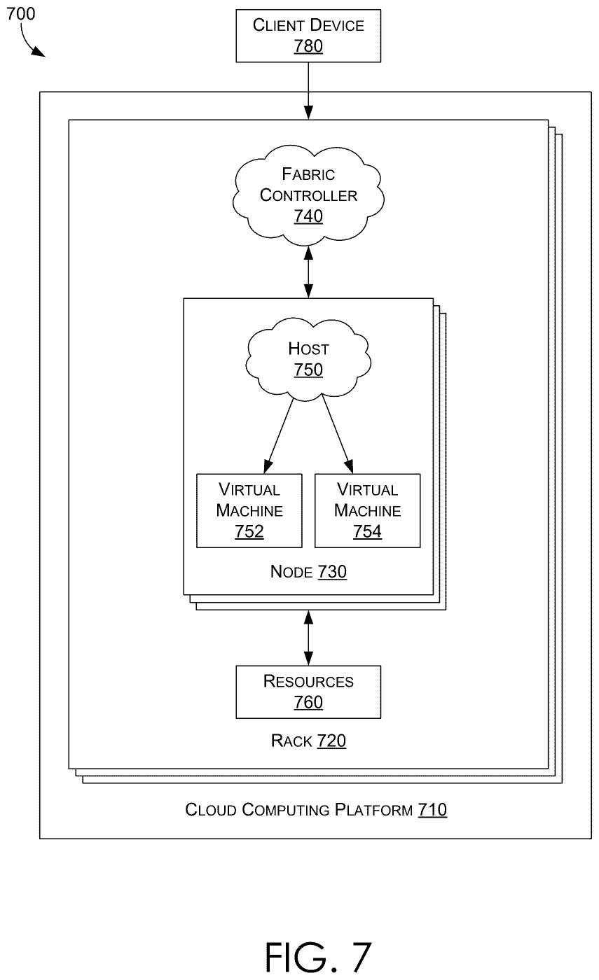

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs)

### Example Computing Environment

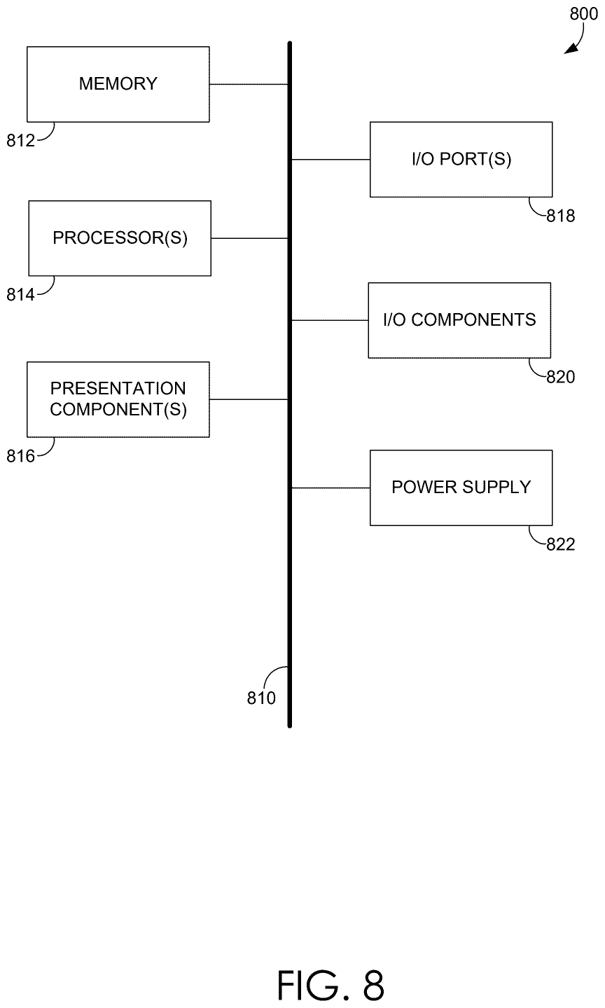

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
generating font category descriptions for font categories that are mapped to fonts;
generating font category embeddings for the font category descriptions;
generating prompt embeddings for a prompt;
using the font category embeddings, the prompt embeddings, and the font categories, identifying at least one heading font candidate;
using a font pairing operation, identifying at least one subheading font candidate for the at least one heading font candidate;
identifying at least one font pairing based on the at least one font heading candidate and the at least one subheading font candidate, the font pairing comprising a heading font and a subheading font; and
communicating the at least one font pairing.

2. The system of claim 1, wherein the at least one font pairing is communicated to a design system service to cause generation of an artificial intelligence generated image comprising the at least one font heading candidate and the at least one subheading font candidate.

3. The system of claim 1, wherein the prompt is a user prompt that is provided via a design system interface associated with generating artificial-intelligence-based designs.

4. The system of claim 1, wherein identifying the at least one heading font candidate is based on:
calculating a similarity between the font category embeddings and the prompt embeddings;
retrieving a plurality of top font categories upon calculating the similarity between the font category embeddings and the prompt embeddings;
using the font categories that are mapped to the fonts, retrieving each font associated the plurality of top font categories;
ranking each font within the plurality of top font categories based on overlap across each font within the plurality of top font categories; and
determining the at least one heading font candidate based on the ranking of each font within the plurality of top font categories.

5. The system of claim 1, wherein identifying the at least one subheading font candidate further comprises generating font visual embeddings, wherein the font visual embeddings are associated with corresponding fonts, the font visual embeddings support matching the heading font candidates to subheading font candidates based on a balance contrast similarity function.

6. The system of claim 1, wherein the font pairing operation is associated with a balance contrast similarity function, font visual embeddings, font stroke width, and font heading candidates to identify corresponding font subheading candidates.

7. The system of claim 1, wherein identifying the at least one font pairing further comprises:
determining similar features of the at least one heading font candidate and the at least one subheading font candidate;
determining different features of the at least one heading font candidate and the at least one subheading font candidate;
ranking a plurality of font pairs of heading font candidates and subheading font candidates based on a balanced contrast similarity function; and
identifying a font pair with a highest ranking from the plurality of font pairs as the at least one font pairing.

8. One or more computer-storage media having computer-executable instructions embodied thereon that, when executed by a computing system having a processor and memory, cause the processor to perform operations, the operations comprising:
accessing font category embeddings for font category descriptions, the font category descriptions are associated with font categories that are mapped to fonts;
accessing prompt embeddings for a prompt;
using the font category embeddings, the prompt embeddings, and the font categories, identifying at least one heading font candidate from the fonts that are mapped to the font categories; and
communicating the at least on heading font candidate.

9. The media of claim 8, wherein the at least one font pairing is communicated to a design system service to cause generation of an artificial intelligence generated image comprising the at least one font heading candidate and the at least one subheading font candidate.

10. The media of claim 8, wherein the prompt is a user prompt that is provided via a design system interface associated with generating artificial-intelligence-based designs.

11. The media of claim 8, wherein identifying the at least one heading font candidate is based on:
calculating a similarity between the font category embeddings and the prompt embeddings;
retrieving a plurality of top font categories upon calculating the similarity between the font category embeddings and the prompt embeddings;
using the font categories that are mapped to the fonts, retrieving each font associated the plurality of top font categories;
ranking each font within the plurality of top font categories based on overlap across each font within the plurality of top font categories; and
determining the at least one heading font candidate based on the ranking of each font within the plurality of top font categories.

12. The media of claim 11, wherein calculating the similarity between the font category embeddings and the prompt embedding is based on a k-nearest neighbors algorithm (KNN) that maps the prompt embeddings with the font category embeddings to determine the plurality of top font categories based on an overlap between the font category embeddings and the prompt embeddings.

13. The media of claim 11, the operations further comprising:
using a font pairing operation, identifying at least one subheading font candidate for the at least one heading font candidate; and
identifying at least one font pairing based on the at least one font heading candidate and the at least one subheading font candidate, the font pairing comprising a heading font and a subheading font.

14. The media of claim 13, wherein the font pairing operation is associated with a balance contrast similarity function, font visual embeddings, font stroke width, and font heading candidates to identify corresponding font subheading candidates.

15. A computer-implemented method, the method comprising:
identifying at least one heading font candidate;
using a font pairing operation, identifying at least one subheading font candidate for the at least one heading font candidate;
identifying at least one font pairing based on the at least one font heading candidate and the at least one subheading font candidate, the font pairing comprising a heading font and a subheading font; and
communicating the at least one font pairing.

16. The method of claim 15, wherein the at least one font pairing is communicated to a design system service to cause generation of an artificial intelligence generated image comprising the at least one font heading candidate and the at least one subheading font candidate.

17. The method of claim 15, wherein identifying the at least one heading font candidate is based on:
calculating a similarity between the font category embeddings and the prompt embeddings;
retrieving a plurality of top font categories upon calculating the similarity between the font category embeddings and the prompt embeddings;
using the font categories that are mapped to the fonts, retrieving each font associated the plurality of top font categories;
ranking each font within the plurality of top font categories based on overlap across each font within the plurality of top font categories; and
determining the at least one heading font candidate based on the ranking of each font within the plurality of top font categories.

18. The method of claim 15, wherein identifying the at least one subheading font candidate further comprises:
filtering through subheading font candidates based on stroke width; and
removing a plurality of subheading font candidates with stroke width greater than a threshold value.

19. The method of claim 15, wherein the font pairing operation is associated with a balance contrast similarity function, font visual embeddings, font stroke width, and font heading candidates to identify corresponding font subheading candidates.

20. The method of claim 15, wherein identifying the at least one font pairing further comprises:
determining similar features of the at least one heading font candidate and the at least one subheading font candidate;
determining different features of the at least one heading font candidate and the at least one subheading font candidate;
ranking a plurality of font pairs of heading font candidates and subheading font candidates based on a balanced contrast similarity function; and
identifying a font pair with a highest ranking from the plurality of font pairs as the at least one font pairing.
